(19) United States
(12) Patent Application Publication
(10) Pub. No.: US 2011/0008564 A1
(43) Pub. Date: Jan. 13, 2011

(54) METHOD OF MANUFACTURING FOAM SHEETS AND PRODUCT THEREOF

(75) Inventor: Hui-Li Wang, Taichung City (TW)

Correspondence Address: Wang Law Firm, Inc., 4989 Peachtree Parkway,, Suite 200, Norcross, GA, 30092, US

(73) Assignee: Min-Chen Chiang, Tanzi Township (TW)

(21) Appl. No.: 12/501,458

(22) Filed: Jul. 12, 2009

(51) Int. Cl. B32B 3/26; B32B 37/12; B32B 33/00

(52) U.S. Cl. 428/41.8; 156/292

(57) ABSTRACT

A method of manufacturing a foam sheet and the product thereof are disclosed. The foam sheet thus formed is cut into several pads. The surrounding of the top surface of each pad is heated, pressed, and cooled to form a guiding angle structure. The bottom surface of the pad is heated, pressed, and cooled to have a pattern. The relatively protruding surface of the bottom surface is coated with an adhesive layer to be attached to the ground. A release paper then covers the adhesive layer. The pads are then patched to form a sheet with the disclosed structure.

### BACKGROUND OF THE INVENTION

1. Field of Invention

The invention relates to a method of manufacturing foam sheets and product thereof. In particular, the invention relates to a method of manufacturing the pad that attaches to the ground and form a sheet and the product thereof.

2. Related Art

FIG. 10 shows a conventional sheet consisted of several pads 90. As shown in the drawing, each pad 90 has a rectangular shape. Each side has a tooth structure 91 for them to combine with each other. The pads 90 also have different colors.

However, the pads 90 in the conventional sheet are usually made by cutting a big sheet. Moreover, the pad 90 is made of a foam material. It is soft and flexible. During the manufacturing process, the thickness of each pad 90 has an appropriate tolerance (usually about ±0.5 mm). Therefore, they have the following problems.

1. Since the pad 90 is a soft material, the joint of the tooth structure 91 is likely to recess or rip apart when they are patched together. Thus, there will be a gap between pads 90. Moreover, as the pads are not completely attached to the ground, dusts can fall into the gaps. After long-time accumulation, the gaps between the pads 90 and between the ground and the pads 90 will be filled with a lot of dusts. As shown in FIG. 1, it may be easier to remove the dusts on the surface of the pads 90 when using a vacuum cleaner. But the dusts between the sheet and the ground are difficult to remove. One has to take apart the pads 90 in order to completely clean it.

2. Each side of the pad 90 has a tooth structure 91. The corner is usually made to have the same color as the pad 90. However, after the pads 90 of different colors are patched, the colors alternate at the junction and have inconsistent differences in colors. Even if pads 90 of the same color are used, their surfaces and sides often have slightly different colors. Moreover, they usually have different heights. Consequently, after they are patched, there are still differences in colors, as shown in FIG. 12. Such a visual difference due to height variations is more prominent.

3. The conventional pads 90 are mostly rectangular. When patching them, one has to consider the problem of joining the tooth structures. Therefore, the variations in shape are limited by the patching method.

4. Another conventional patching sheet is attached to the ground with a glue coating on the back. However, usually the glue is all over the bottom surface and too adhesive to remove in the future. They may be broken or have residues on the ground when being removed. One thus has to use some specific glue with appropriate strength. Such glue is more expensive than normal glue. It is then another issue to use an appropriate amount of glue in order to reduce the cost.

Therefore, it is an objective to solve the above-mentioned problems in conventional pads 90 of patching sheet.

### SUMMARY OF THE INVENTION

One objective of the invention is to solve the above-mentioned problems by providing a method of manufacturing foam pads and the product thereof. The bottom surface of the pad is coated with an adhesive material to be attached to the ground. A guiding angle structure is formed around the top surface of the pad by thermal pressing. With such a structure, the pads are tightly attached to the ground and connected to each other. This avoids dusts from falling therein. It also prevents the tooth structure from protruding. Besides, the guiding angle structure of the pad renders a better visual effect in the patched pads.

Another objective of the invention is to properly design the structure of the bottom surface of the pad, so that the pad can be attached to the ground with less glue. It also achieves the effects of soundproof and preventing mould from growing.

To achieve the above-mentioned objectives, the disclosed method involves the following steps: heating and pressing around the top surface of each pad and cooling it to form a guiding angle structure; heating the bottom surface of the pad and pressing and cooling to form a pattern; coating an adhesive layer on the relatively protruding surface of the bottom surface for attaching to the ground; and covering the adhesive layer with a release paper.

The disclosed pad product has: a guiding angle structure around the top surface of the pad, a pattern on its bottom surface, an adhesive layer on the relatively protruding surface of the pattern for attaching to the ground, and a release paper covering the adhesive layer.

### BRIEF DESCRIPTION OF THE DRAWINGS

The invention will become more fully understood from the detailed description given herein below illustration only, and thus is not limitative of the present invention, and wherein:

FIG. 1 is a schematic view of the sheet formed by the disclosed pads;

FIG. 2 is a schematic view showing how to make the top surface of the disclosed pad;

FIG. 3 is a schematic view of forming the guiding angle structure with a mold according to the invention;

FIG. 4 is a schematic view of forming the bottom surface and coating an adhesive layer thereon according to the invention;

FIG. 5 is a schematic view of the disclosed pad structure;

FIG. 6 is a schematic view of patching the disclosed pads on the ground;

FIG. 7 is a schematic view of cleaning the disclosed pads;

FIG. 8 is a schematic view of looking at the surface of the disclosed pad;

FIG. 9 shows a second embodiment of patching the pads;

FIG. 10 is a schematic view of conventional pads patched together;

FIG. 11 is a schematic view of cleaning the pads of conventional sheet; and

FIG. 12 is a schematic view of looking at the surface of the disclosed pad.

### DETAILED DESCRIPTION OF THE INVENTION

The present invention will be apparent from the following detailed description, which proceeds with reference to the accompanying drawings, wherein the same references relate to the same elements.

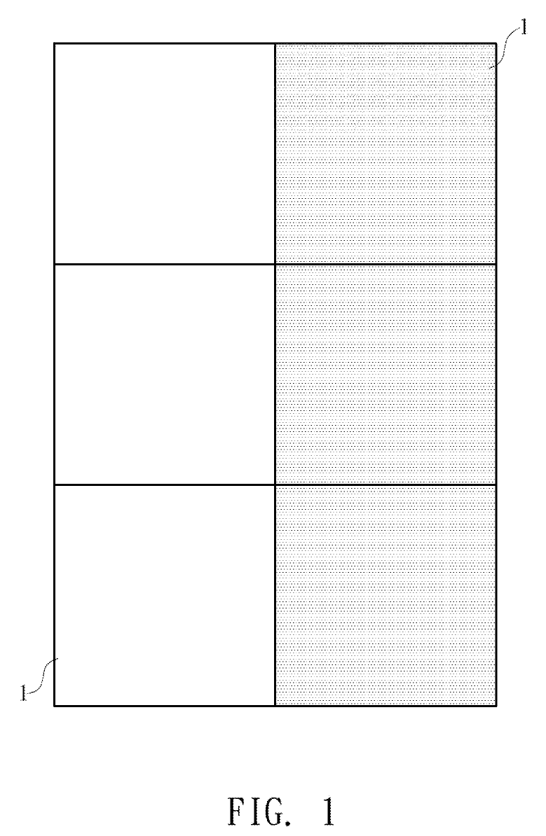

Please refer to FIGS. 1 to 9 for embodiments of the invention. They are used for the purpose of explanation and should not be used to restrict the scope of the invention.

This embodiment provides a method of manufacturing a foam sheet. It is then cut into several pads 1 that can be patched into the sheet show in FIG. 1.

According to the disclosed method, the surrounding of the top surface 11 of each pad 1 is thermally pressed to form a guiding angle structure. The bottom surface 12 of the pad 1 is heated, pressed, and cooled to form a pattern. An adhesive layer 13 is coated on the relatively protruding part of the bottom surface 12 to be attached to the ground. A release paper 2 the covers the adhesive layer 13.

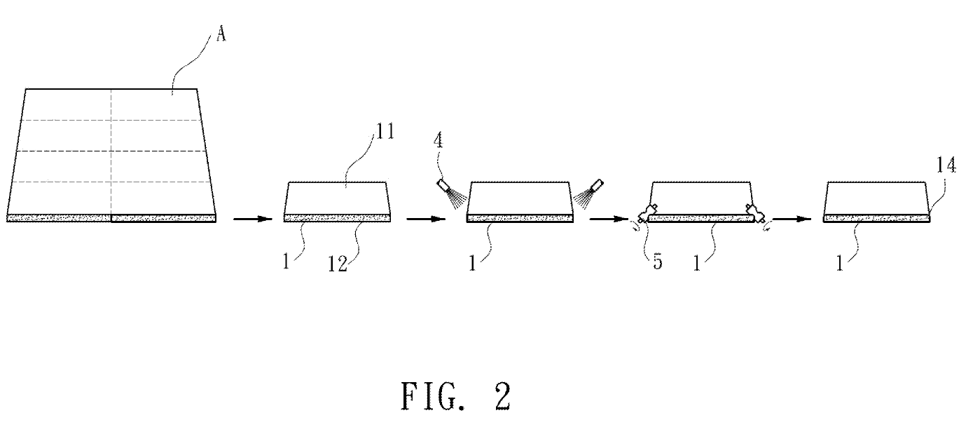

As shown in FIG. 2, the pad 1 in this embodiment is made of an ethylene vinyl acetate (EVA) foam material. Moreover, the pad 1 is obtained by cutting a big sheet A into a rectangular shape. The adhesive layer 13 on the bottom surface 12 of the pad 1 is cut along with the sheet A. In this embodiment, the guiding angle structure of the pad 1 is first heated and softened by hot air from a hot wind device 4, followed by pressing of a roller 5. The roller 5 has a cooling circulation pipeline with cooling water circulating therein (not shown). Therefore, the guiding angle structure is formed by roller pressing and cooling.

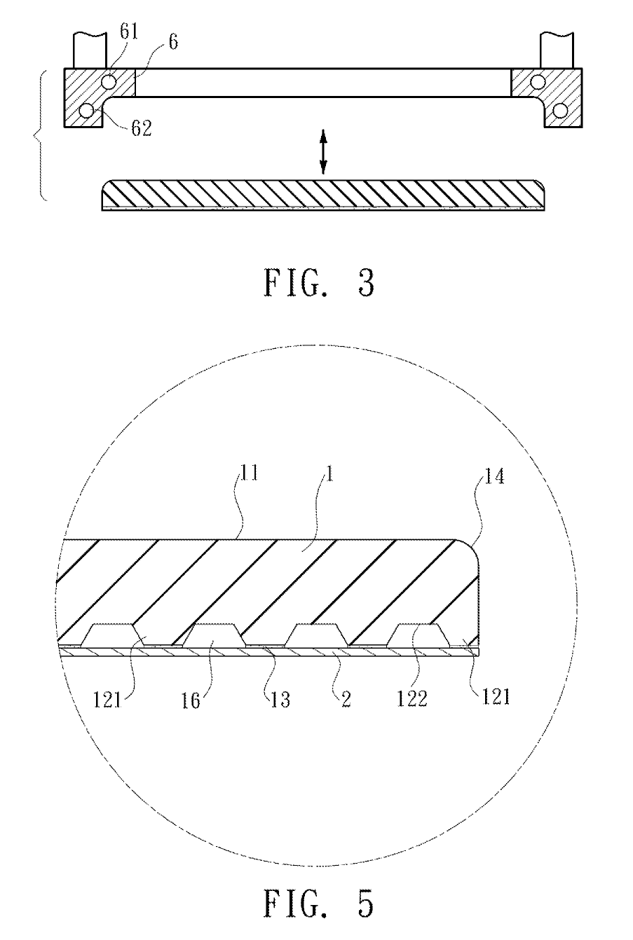

Besides, the guiding angle structure can be substituted by some other equivalent process in another embodiment. As shown in FIG. 3, the mold 61 corresponding to the guiding angle structure of the pad 1 has an electric heating pipe 61 and a cooling water circulating pipeline 62. Therefore, the mold 6 presses against the surrounding of the top surface 11 of the pad 1 after being heated. At the same time, it cools to form the guiding angle structure.

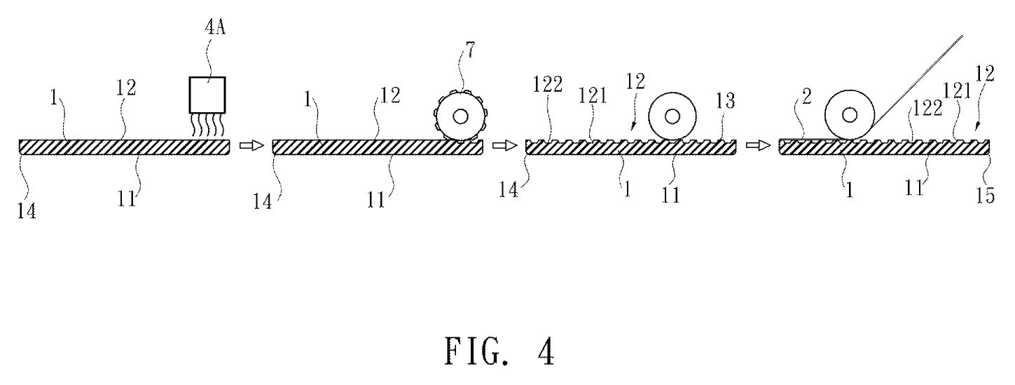

As shown in FIG. 4, the pattern on the bottom surface 12 of the pad 1 in this embodiment is formed by using another hot wind device 4A to blow hot air. The bottom surface 12 of the pad is thus softened and pressed by a roller 7 with a pattern, leaving the corresponding pattern on the pad 1. An adhesive material is then coated on the pattern with the roller, forming the adhesive layer 13. Another roller then put the release paper 2 on the adhesive layer 13.

In the above-mentioned pad 1, the guiding angle structure on the top surface 11 and the pattern on the bottom surface 12 can be simultaneously completed in one transporting process or subsequently in one process or different processes.

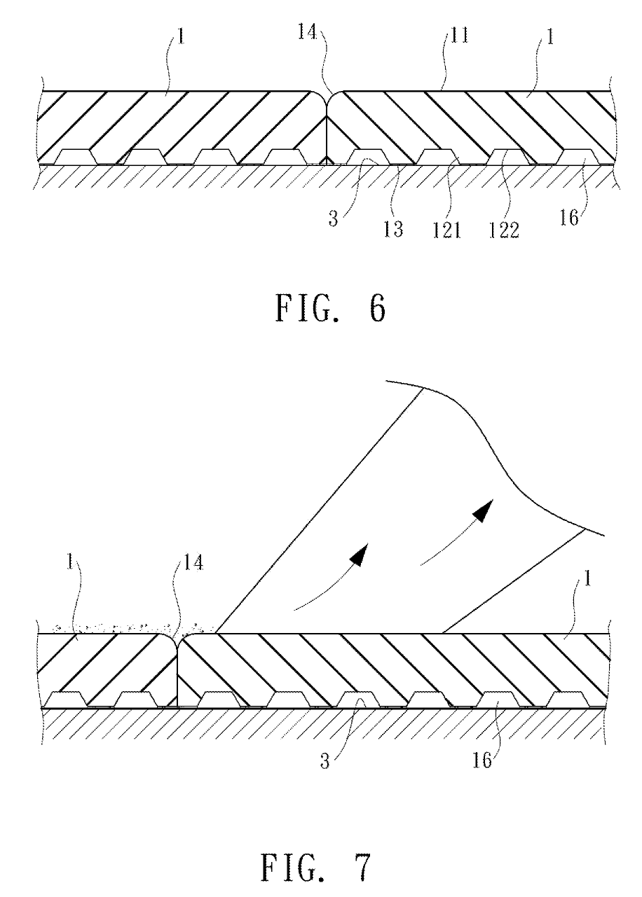

The foam sheet product prepared according to the above-mentioned method of the invention is shown in FIGS. 5 and 6. As shown in the drawing, a guiding angle part 14 is formed around the top surface 11 of the pad 1. The bottom surface 12 has a pattern with alternating protruding part 121 and receding part 122. The surface of the protruding part 121 has an adhesive layer 13 to be attached to the ground. A release paper 2 covers the adhesive layer 13. The receding part 122 of the bottom surface 12 and the ground 3 provide a space 15 for air to flow when the pad is attached to the ground 3.

From the above description, it is not difficult to discover the following primary advantages of the invention:

1. The pad 1 is attached to the ground 3. The pads 1 are tightly patched to avoid dusts from falling in between. Even though the guiding angle structure (guiding angle part 14) may have dusts accumulated thereon, they do not get between the pads 1 as they are tightly patched. It is relatively easy to clean the pads 1. For example, as shown in FIG. 7, the dusts are readily removed by a vacuum cleaner.

2. Conventional pads are mostly rectangular. Therefore, one has to consider the junction problem of the tooth structure when patching them together. The shape of the pads is thus very limited. According to the invention, the pads 1 are fixed by attaching. Therefore, there is no limitation in the shape. Besides, the disclosed pad 1 is visually more beautiful after patching because of the guiding angle structure (guiding angle part 14).

3. After the formation of a usual pad, its surface is printed with a color. As shown in FIG. 8, the color layer 16 printed on the surface of the disclosed pad extends along the edge of the guiding angle structure (guiding angle part 14). Consequently, after the pads are patched together, the printed color is continuous even if there is a height difference between pads. This is because of the curvature of the guiding angle structure (guiding angle part 14). The invention is thus visually consistent in color, unlike conventional pads.

4. The bottom surface 12 of the disclosed pad 1 has a pattern. The adhesive layer 13 is only provided on the surface of the protruding part 121. Therefore, the amount of adhesive material is less than the prior art, thereby reducing the cost thereof. Moreover, the pattern formed on the bottom surface 12 of the pad 1 renders a better soundproof effect. Besides, the space 15 formed between the receding part 122 and the ground 3 allows airflow to suppress the growth of mould.

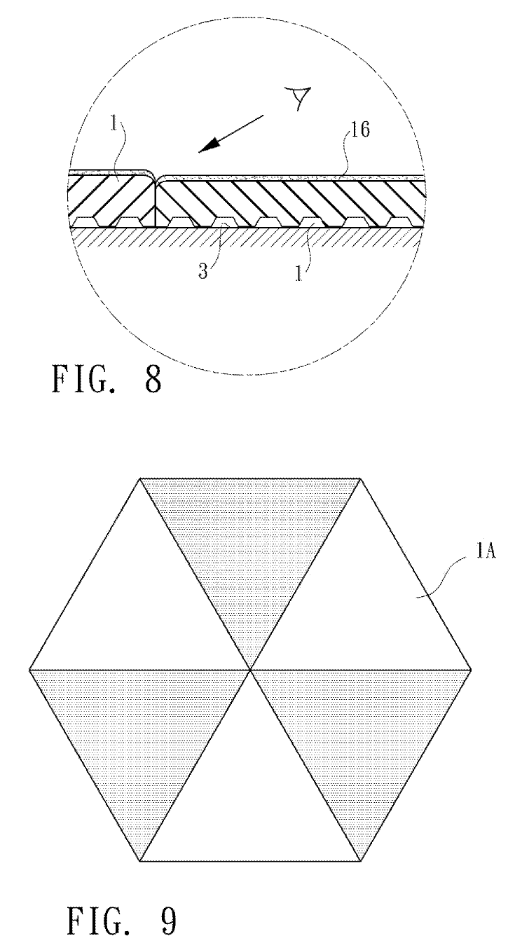

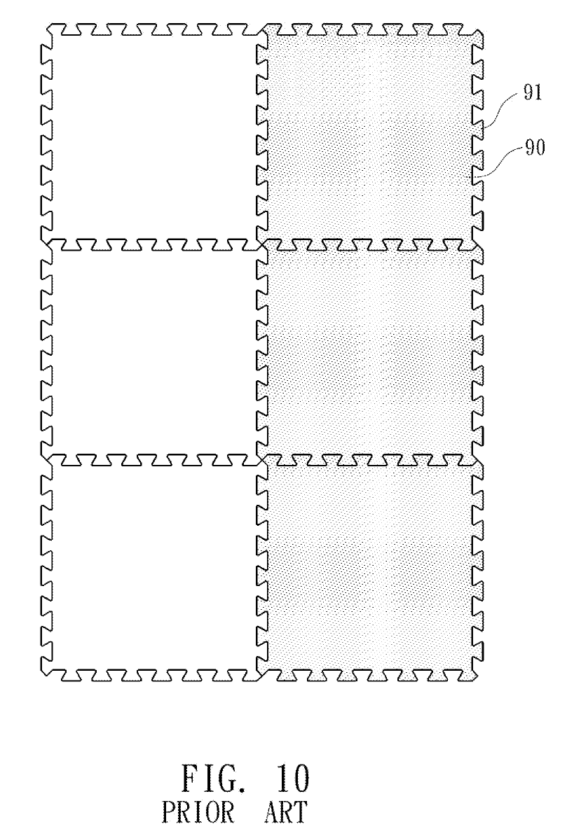

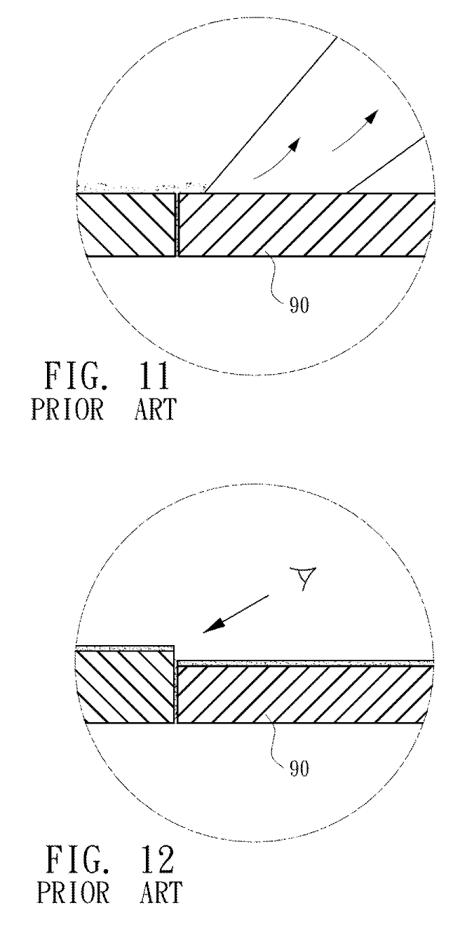

Of course, the invention has many other embodiments that differ from the one disclosed herein in detail. Please refer to FIG. 9 for a second embodiment. Each pad 1A has a triangular shape. They are patched into a hexagonal sheet structure. As described in the advantages of the first embodiment, the disclosed pads 1 are fixed to the ground by attaching. Therefore, one can freely design the shape of pads. In comparison with the conventional pad, the invention does not have the restriction due to the tooth structure. It is therefore very flexible and convenient.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A method of manufacturing a foam sheet to be cut into a plurality of pads, comprising the steps of:
forming a guiding angle structure by heating, pressing, and cooling around the top surface of each pad or by heating and pressing around the top surface of each pad and then cooling it;
heating the bottom surface of the pad and pressing and cooling to form a pattern;
coating an adhesive layer on the relatively protruding surface of the bottom surface for attaching to the ground; and
covering the adhesive layer with a release paper.

2. The method of manufacturing a foam sheet according to claim 1, wherein the guiding angle structure on the top surface and the pattern on the bottom surface of the pad are first heated and softened, followed by cooling formation.

3. The method of manufacturing a foam sheet according to claim 1, wherein the guiding angle structure on the top surface and the pattern on the bottom surface of the pad are formed by heating, pressing, and cooling with a respective mold of a corresponding structure.

4. The method of manufacturing a foam sheet according to claim 1, wherein the surrounding of the top surface of the pad has a guiding angle structure and the bottom surface has a pattern with alternating protruding part and receding part, the surface of the protruding part is coated with an adhesive layer to be attached to the ground, a release paper covers the adhesive layer, and a space for airflow is formed between the receding part and the ground.

5. The method of manufacturing a foam sheet according to claim 4, wherein the guiding angle structure on the top surface and the pattern on the bottom surface of the pad are first heated and softened, followed by cooling formation.

6. The method of manufacturing a foam sheet according to claim 4, wherein the guiding angle structure on the top surface and the pattern on the bottom surface of the pad are formed by heating, pressing, and cooling with a respective mold of a corresponding structure.

7. The form sheet product of claim 4, wherein the guiding angle of the pad is a guiding arc angle.
